(19) United States
(12) Patent Application Publication
(10) Pub. No.: US 2007/0182131 A1
(43) Pub. Date: Aug. 9, 2007

(54) Housing for an airbag device

(76) Inventors: Michael Helbig, Munchen (DE); Stefan Brands, Aichach (DE); Hans-Georg Bottesch, Herbertshausen (DE); Ingolf Prys, Landsham (DE)

Correspondence Address: BRINKS HOFER GILSON & LIONE, P.O. BOX 10395, CHICAGO, IL, 60610, US

(21) Appl. No.: 10/570,918

(22) PCT Filed: Aug. 27, 2004
(86) PCT No.: PCT/EP04/09624

§ 371 Date: Dec. 15, 2006

(30) Foreign Application Priority Data
Sep. 3, 2003 (DE) 10340513.5

(51) Int. Cl. B60R 21/21; B60R 21/217

(52) U.S. Cl. 280/728.2; 280/730.2; 280/728.3

(57) ABSTRACT

The invention relates to a housing (5) for an airbag device (4) on a motor vehicle, with a hollow space for acceptance of a container (8) of a gas generator (9) and an airbag (12), whereby the housing (5) includes a main structure and a housing cover which is connected to it and which faces the vehicle occupants when installed, on whose inner side at least one material weakness is formed, which can tear open if airbag (12) unfolds in order to retain the vehicle occupants. To improve the outer appearance of such a housing (5) it is provided that material weaknesses (16, 17) are so slight that they are not visible from the side of housing cover (6) facing the passenger compartment, and that housing cover (6) is also connected with basic housing structure (27) by means of at least one perforation (13).

### CROSS REFERENCE TO RELATED APPLICATIONS

This application claims priority to German patent application number 103 40 513.5, filed Sep. 3, 2003 and PCT/EP2004/009624, filed Aug. 27, 2004.

### FIELD OF THE INVENTION

This invention relates to a housing for an airbag device for a motor vehicle.

### BACKGROUND OF THE INVENTION

Side airbag devices are known such as that described by WO00/06421 A1 for protection of vehicle occupants of the rear seat of a vehicle. The side airbag device in accordance with the previously mentioned reference is formed and attached to the vehicle body in the area of door opening in such a way that its airbag pushes between a vehicle occupant and the inner wall of the vehicle structure in cases where the vehicle occupant has to be restrained.

In another example of known devices, EP 0 826 565 A2 describes a side airbag module which is located at the side in the backrest of a motor vehicle seat. In the case of this side airbag module, a gas generator and an airbag are embedded in the foam of the backrest in such a way that only a housing cover and seams in the seat cover indicate the presence of the side airbag module. In addition, a weakness in the material is formed in the foam and in the housing cover respectively, which is not visible from the outside, and function in the manner of a tear line when the airbag unfolds, driven by the gas generator.

In addition, an elastic housing cover for an airbag device on a vehicle steering wheel is known from DE 197 30 837 A1 in which this housing cover exhibits set and defined break locations at least in some areas, which are torn open to allow the release of an unfolding airbag to retain vehicle occupants in case of an accident. In order to achieve a good outer appearance as regards the housing cover, these set break points, which are in the form of perforations, are located in a fixing section not visible from the inside of the vehicle.

Finally, side airbag devices with a plastic housing are known, having a hollow container for accommodating a gas generator as well as an airbag. In addition, such a housing includes a housing cover which faces towards the vehicle occupants when mounted, on whose inner side at least one material weakness is provided in the form of a tear line, which can be torn open in case of accident by the unfolding airbag in order to retain the vehicle occupants.

A disadvantage of the previously described side airbag devices is that the material weaknesses in the outside airbag covers are formed in such a pronounced way as deep grooves that are visible from the side of the housing cover which faces towards the vehicle occupants. This has a negative effect on the overall interior aesthetics of the vehicle, so that a means of avoiding this effect would be useful.

Against this background, it is an object of this invention to present a housing for an airbag module which is formed so that it can be torn open by the unfolding airbag in the event an airbag deployment while the housing cover facing the passenger compartment does not reveal that material weaknesses present in the airbag housing.

### SUMMARY OF THE INVENTION

This invention is based on the recognition that the aforementioned weaknesses in the airbag cover material are visible because they are comparatively deep in form. Specifically, this material weakness is formed in the described state of the art in such a way that only a very thin material skin is present.

In order to prevent the weaknesses from being visible, it is first intended to make the material weakness of the housing cover in the area of the tear lines less pronounced than in the prior art, so that this material weakness is no longer visible from the passenger compartment side.

As the forces for tearing open the airbag cover which can be applied by the unfolding airbag are limited, a preferably concealed tear line is additionally provided, which is easier to tear open that the aforementioned material weaknesses in the housing body. For this purpose, this tear line is formed in the housing of the airbag module by a perforation in such a way that the perforation exhibits comparatively large gaps and small solid sections of material. This perforation preferably replaces a weakness in the material formed in the state of the art by means of a cut-out of the material in the housing cover.

The result of the invention is that the weakness in the material is no longer visible and the housing cover can be torn open with the same airbag forces as in conventional airbag devices.

According to this invention, a housing for an airbag device in a motor vehicle is provided with a hollow space for accommodation of a container of a gas generator and an airbag. In addition, the housing includes a housing cover which is connected with the housing and faces the vehicle occupants when mounted in the vehicle. At least one material weakness is formed on the inner side of the housing cover, which can be torn open upon airbag deployment.

In order to address the above mentioned design objectives, in combination with the aforementioned characteristics it is also intended that the material weaknesses of the cover are so slight that they are not visible from the side of the housing cover which faces towards the vehicle interior, and that the housing cover is also connected with the main housing structure by means of a perforations.

The perforations are preferably formed at a location on an area of the housing which is not visible to the vehicle occupants when installed in the vehicle.

Furthermore, in a further development of the invention the perforation is covered by a section of the housing.

In order now to be able to achieve particularly advantageous upwards opening of the housing cover away from the main housing structure, it is preferably provided that the axis of the tear line of the perforation is basically parallel to the vertical axis of the vehicle.

In another embodiment of the housing according to the invention, the perforation is formed on a housing section of the basic housing structure on the vehicle body side. Within this arrangement, the perforation is formed in an area of the housing where there is no other material by means of bridges, which form a connection between the housing section on the vehicle body side and the housing cover.

In order to be able to ensure optimum tearing and upwards opening of the housing cover, it is also preferable that the perforation and the at least one material weakness are basically orientated vertically to one another. This means that two material weakness lines and one perforation line form a basically rectangular tear-open window, through which the unfolding airbag can exit from the housing of the airbag module.

In order to make the upwards opening of the aforementioned tear-open window in the housing cover easier, it is preferably provided that a further material weakness is formed on the inner side of the housing cover, which is located to close to, and in parallel axis to, an opening axis, or hinging axis of rotation, in this housing cover.

This material weakness in the area of the aforementioned axis of rotation is preferably formed in such a way that there the housing cover does not tear away from the housing, but nevertheless it is possible for a part of the housing cover to flap open by means of the unfolding airbag.

The housing according to the invention can be used for all types of airbag devices. Preferably it is used for side airbag devices in motor vehicles.

### BRIEF DESCRIPTION OF THE DRAWINGS

The invention is described in more detail below by means of an embodiment which is shown in the drawings in schematic form. The drawings are as follows:

FIG. 1 is a view of a side airbag device in the area of a rear seat of a motor vehicle including a housing in accordance with this invention,

FIG. 2 is a cross-section through the side airbag device according to FIG. 1 along line A-A,

FIG. 3 is a view of the side airbag device according to FIG. 2 of a housing part on the vehicle side, and

FIG. 4 is a frontal view of the side airbag device according to FIG. 1 in non-installed state.

### DETAILED DESCRIPTION OF THE INVENTION

The figures show, the side airbag module 4 which is of the type which is fixed to a motor vehicle body 22 in the area of a door opening 1. Within this arrangement, side airbag module 4 is basically arranged between door opening 1 and the backrest 3 of a seat 2, whereby an area of side airbag module 4 indicated by means of a dotted line is covered from view by vehicle occupants by backrest 3.

In a case where vehicle occupants have to be restrained, for example, in case of a side impact by another vehicle on the side structure of vehicle body 22, the passenger compartment housing cover 6 of airbag module 4 is partly torn open by expanding airbag 12, so that the airbag basically exits from the cover in the forward direction relative to longitudinal vehicle axis 24.

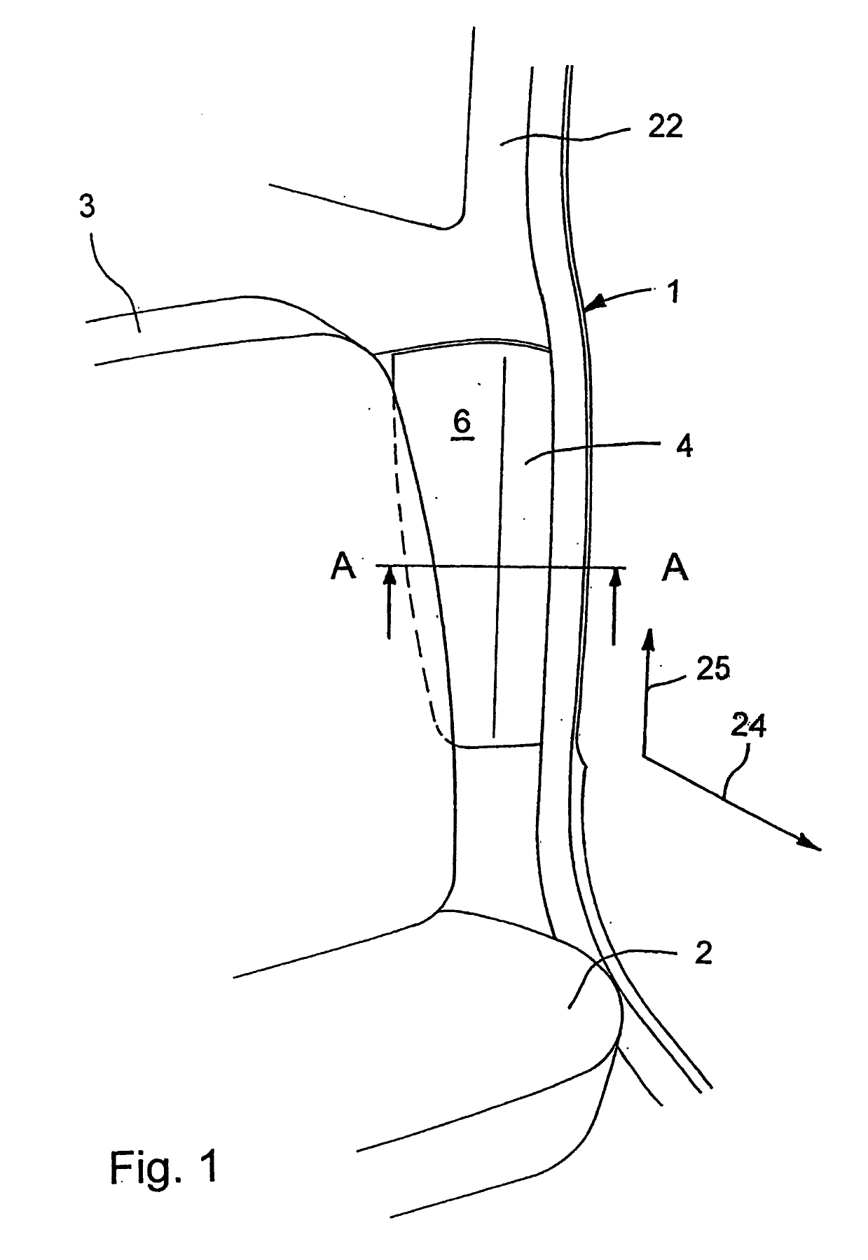

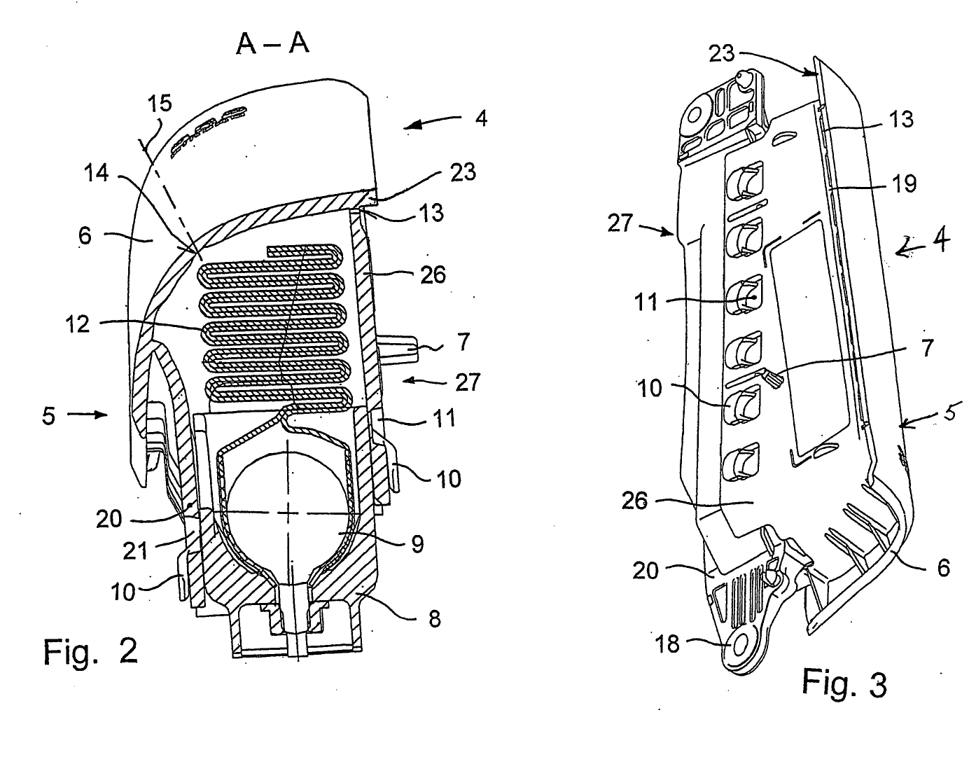

FIG. 2 shows, in a cross-section through side airbag module 4 according to FIG. 1, that a housing 5 with main housing structure 27 forms the exterior of the undeployed side airbag module 4, which basically includes a vehicle body side housing section 26, a passenger compartment side housing section 20 and a housing cover 6.

A container 8 for a gas generator 9 as well as of a folded airbag 12 are inserted into housing 5 and fixed by means of fixing hooks 10 which can be installed into fixing openings 11 and 21 of housing 5. As the view according to FIG. 3 of the vehicle body side housing section 26 in particular shows, an alignment or centering peg 7 is also formed on this housing section, which can be inserted into a corresponding acceptance opening in vehicle body 22 as an assembly aid.

In addition, a fixing section 18 is formed by the vehicle body side housing section 26, through whose opening a fastener such as a threaded bolt, for example, can be guided on the vehicle body 22 and the side airbag device 4 and can be screwed fast.

As the cross-section through housing cover 6 of housing 5 in FIG. 2 as well as the side views of the airbag module 4 clearly show, this housing cover 6 is connected with the vehicle body side housing section 26 by means of a perforation section. This perforation 13 is formed of a section which is basically free of material, in which bridges 19 provide for a connection between the two aforementioned portions 6 and 26 of module housing 5. In this arrangement, the perforation openings, or the width of bridges 19, are formed in such a way that the forces which unfold the airbag 12 upon deployment can tear the bridges open easily, but ensure than in normal cases the airbag module 4 is securely closed.

In order that perforation 13 is not visible to the vehicle occupants, the perforation is located on the vehicle body side housing section 26 and is preferably also covered by a cover section 23 of housing cover 6.

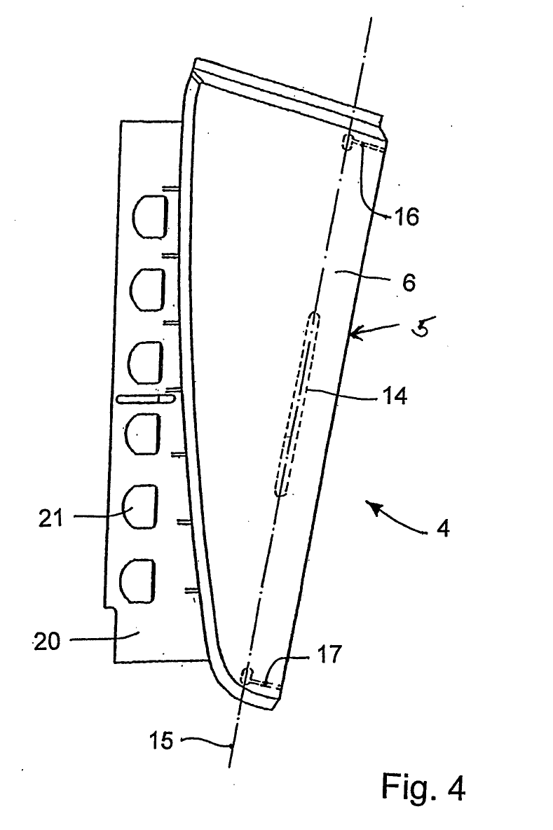

As FIG. 2 in connection with FIG. 4 shows, material weaknesses 14, 16 and 17 are provided on the inner side of housing cover 6, which are basically orientated vertically to one another. These material weakness are preferably formed as grooves or cut-outs in housing cover 6, whose depth differs depending on use.

While side edge material weaknesses 16 and 17 are so considerable that the forces applied to housing cover 6 by unfolding airbag 12 are sufficient to tear open the housing at these locations, hinge material weakness 14 is designed in such a way that it defines a hinge and does not tear away and only allows the opening window of side airbag device 4 thus formed to flap open around a axis of rotation 15 which takes effect in the area of this material weakness 14.

This axis of rotation 15 provided by the hinge formed by material weakness 14 is preferably formed in such a way that it is orientated basically so as to be parallel to vertical vehicle axis 25 (FIG. 1). In this embodiment, this construction therefore also determines the orientation of tear line of perforation 13, whose axis is also orientated parallel to the vertical vehicle axis (25).

As the above explanations make clear, the structure of housing 5 of airbag module 4 according to the invention achieves the effect that material weaknesses 14, 16 and 17 are not visible on the housing cover 6 which faces the passenger compartment, and that side edge material weaknesses 16 and 17 can nevertheless be opened by the forces of an unfolding airbag 12.

In order that the housing 5 of the airbag module 4 can implement the features according to the invention as well as the aforementioned embodiments and further developments of the invention, it is provided that the housing is manufactured of plastic, preferably of thermoplastic type.

Regardless of the fact that housing 5 according to the invention is particularly suitable for side airbag devices which are fixed onto the vehicle body as illustrated, it is also within the scope of the invention to mount the side airbag module in seat backs.

While the above description constitutes the preferred embodiment of the present invention, it will appreciated that the invention is susceptible to modification, variation and change without departing from the proper scope and fair meaning of the accompanying claims.

1. A housing for an airbag module for a motor vehicle of the type including a gas generator and an airbag, the airbag being deployable for providing impact protection for vehicle occupants, comprising the housing forming, a hollow space for accommodation of the gas generator and the airbag, the housing further having a main housing structure and a housing cover connected with the main housing which faces the vehicle occupants when installed, the main housing inner side forming at least one side edge material weakness, defining an edge of the cover which can be torn open upon deployment of the airbag and a hinge material weakness defining a hinge for the opening of the cover upon the deployment, the side edge and hinge material weakness being invisible as viewed from the side of the housing cover facing the vehicle occupant, and the housing cover is additionally connected with the main housing structure by means of one or more perforation.

2. A housing according to claim 1, wherein the one or more perforation is formed on a part of the housing which is not visible to the vehicle occupants when installed.

3. A housing according to claim 1, wherein the axis of the tear line of perforation is orientated generally parallel to the vertical axis of the vehicle.

4. A housing according to claim 1, wherein the one or more perforation is formed on a vehicle body side housing section of the housing.

5. A housing according to claim 1, wherein the one or more perforation is formed between bridges, which create a connection between a vehicle body side housing section and the housing cover of the housing and wherein the connection fails upon deployment of the airbag causing the cover to tear away from the main housing as the cover tears at the side edge material weaknesses and hinges about the hinge material weakness.

6. A housing according to claim 1, further comprising in that the one or more perforation is overlapped by a section of the one or more housing cover.

7. A housing according to claim 1, further comprising in that the one or more perforation and the at least one material weakness are arranged generally vertically to one another.

8. A housing according to claim 1, further comprising in that the hinge material weakness is formed on an inner side of housing cover, which is close to and parallel to an axis of rotation of the housing cover upon deployment of the airbag.

9. A housing according to claim 8, further comprising in that the hinge material weakness in the area of a flap axis is formed in such a way that the housing cover does not tear open there.

10. A housing according to claim 1, further comprising in that housing is composed of a plastic material.

11. A housing according to claim 1, further comprising in that the housing is formed as the housing of a side airbag device.
